(19) United States
(12) Patent Application Publication
(10) Pub. No.: US 2024/0427137 A1
(43) Pub. Date: Dec. 26, 2024

(54) SCANNING UNIT OF A POSITION-MEASURING DEVICE

(71) Applicant: AMO Automatisierung Messtechnik Optik GmbH, St. Peter am Hart (AT)

(72) Inventors: Wolfgang Adlhart, Burgkirchen (AT); Andreas Pommer, Burgkirchen (AT); Helmut Huber, Garching/Wald a.d. Alz (DE)

(21) Appl. No.: 18/744,746

(22) Filed: Jun. 17, 2024

(30) Foreign Application Priority Data
Jun. 21, 2023 (EP) 23180649.8

(51) Int. Cl. G02B 26/10

(52) U.S. Cl. CPC G02B 26/103

(57) ABSTRACT

A scanning unit of a position-measuring device includes a housing and one or more through-openings arranged in the housing for fastening the scanning unit to an object. One or more fastening elements extend in each case through a respective one of the one or more through-openings. One or more flexible elements extend in each case at least partially through a respective one of the one or more through-openings and are configured to press the housing against a reference element.

### CROSS REFERENCE TO RELATED APPLICATIONS

This application claims benefit to German Patent Application No. EP 23180649.8, filed on Jun. 21, 2023, which is hereby incorporated by reference herein.

### FIELD

The present invention relates to a scanning unit of a position-measuring device.

### BACKGROUND

DE 10 2014 213 955 A1 discloses a device with a scanning unit and an assembly aid with which the scanning unit is rotatable about an axis of rotation of a reference element. The assembly aid is configured to press the scanning unit thereby resiliently against the reference element.

Further devices for fixing a relative position between a scanning unit and a measuring standard are known from WO 02/40947 A1, U.S. Pat. No. 4,639,595 A, DE 43 04 914 A1 and EP 2 905 582 A1.

### SUMMARY

In an embodiment, the present disclosure provides a scanning unit of a position-measuring device. The scanning unit includes a housing and one or more through-openings arranged in the housing for fastening the scanning unit to an object. One or more fastening elements extend in each case through a respective one of the one or more through-openings. One or more flexible elements extend in each case at least partially through a respective one of the one or more through-openings and are configured to press the housing against a reference element.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a perspective exploded view of a position-measuring device according to a first exemplary embodiment with continuous flexible elements;

FIG. 2 shows a perspective exploded view of a position-measuring device according to a second exemplary embodiment with continuous flexible elements;

FIG. 3 shows a side view of the position-measuring device according to FIG. 2 with a sectional line A-A and a sectional line B-B;

FIG. 4a shows a sectional view along the sectional line A-A in FIG. 3;

FIG. 4b shows a sectional view along the sectional line B-B in FIG. 3;

FIG. 5a shows a sectional view analogous to the sectional view according to FIG. 4a with a flexible element with a first pair of partial sections;

FIG. 5b shows a sectional view analogous to the sectional view according to FIG. 4b with a flexible element with a second pair of partial sections;

FIG. 6a shows a sectional view analogous to the sectional view according to FIG. 4a with a flexible element with a single partial section; and

FIG. 6b shows a sectional view analogous to the sectional view according to FIG. 4b with a flexible element with a single partial section.

### DETAILED DESCRIPTION

In an embodiment, the present invention provides a scanning unit of a position-measuring device that is compact and cost-efficient to build and with which simple assembly with high accuracy is made possible.

The scanning unit according to an embodiment of the invention comprises a housing, one or more through-openings disposed in the housing for fastening the scanning unit to an object and one or more fastening elements extending through the through-openings. The scanning unit has one or more flexible elements. The one or more flexible elements extend at least partially through the through-openings. The one or more flexible elements are configured to press the housing of the scanning unit against a reference element.

Preferably, a pre-tensioning device is formed by the flexible elements and the fastening elements. The pre-tensioning device can also be referred to as an assembly aid.

It is advantageous if the flexible elements are configured to generate a predetermined pressing force that presses the housing of the scanning unit against the reference element.

Furthermore, it is advantageous if the flexible elements are configured to pre-tension the fastening elements in the through-openings in such a way that the predetermined pressing force is generated.

Preferably, the flexible elements are configured in a tubular manner (e.g. hollow-cylindrically).

Preferably, the flexible elements are elastically deformable elements. For example, the flexible elements are made of silicone or rubber.

Preferably, the fastening elements are configured as fastening screws or fastening bolts.

In another embodiment, the present invention provides a position-measuring device with a measuring standard and the scanning unit according to an embodiment of the invention.

It is advantageous if the position-measuring device has the reference element and if the reference element is disposed between the measuring standard and the scanning unit.

Preferably, the reference element is a flexible film with a predetermined thickness and/or a predetermined curvature. For example, the predetermined thickness corresponds to a distance between the measuring standard and the scanning unit. Furthermore, the predetermined curvature is adapted, for example, to a radius and/or diameter of the measuring standard (in the case of a rotatory position-measuring device). In the case of a linear position-measuring device, the flexible film can be adapted to a plane of the measuring graduation of the measuring standard. In an advantageous manner, the flexible film serves as a spacer element.

Embodiments of the invention enable a simple assembly of a position-measuring device with a compact and cost-effectively built scanning unit. The position-measuring device comprises a measuring standard and the scanning unit. When assembling the position-measuring device, a high degree of accuracy, i.e. a precise (and/or essentially error-free) setting of a distance (hereinafter referred to as the scanning gap) between the measuring standard and the scanning unit is achieved. The assembly comprises, for example, the following steps: (i) arranging a reference element between the measuring standard and the scanning unit; (ii) stationary fastening of the scanning unit to an object in such a way that the housing of the scanning unit is pressed against the reference element by flexible elements integrated in the scanning unit; and (iii) removal of the reference element from the measuring standard and the scanning unit. In particular, the invention enables a defined pressing (and/or a flexible spring force) of the scanning unit against the reference element. As a result, errors or inaccuracies during assembly, e.g. due to improper manual pressing of the scanning unit, can be avoided. The high accuracy of the assembly and/or the error-free setting of the scanning gap are thus achieved.

Further details and advantages of the present invention are explained with reference to the following description of exemplary embodiments of the invention in conjunction with the figures.

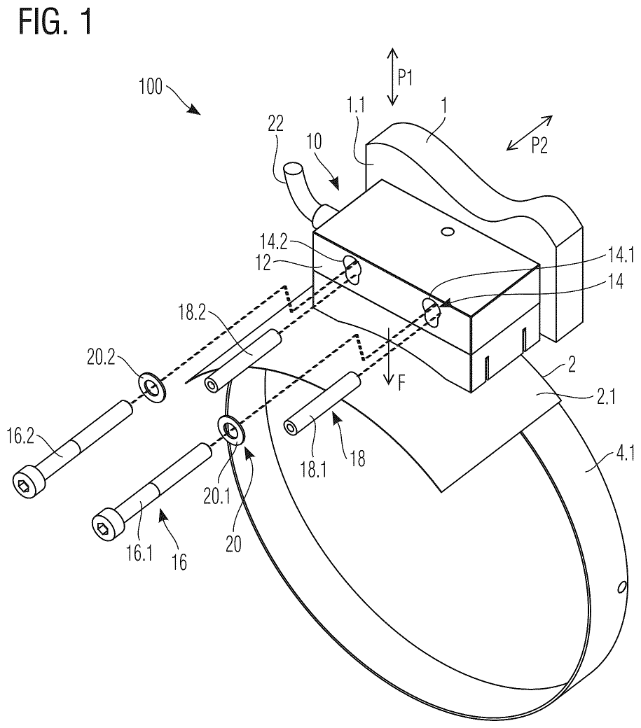

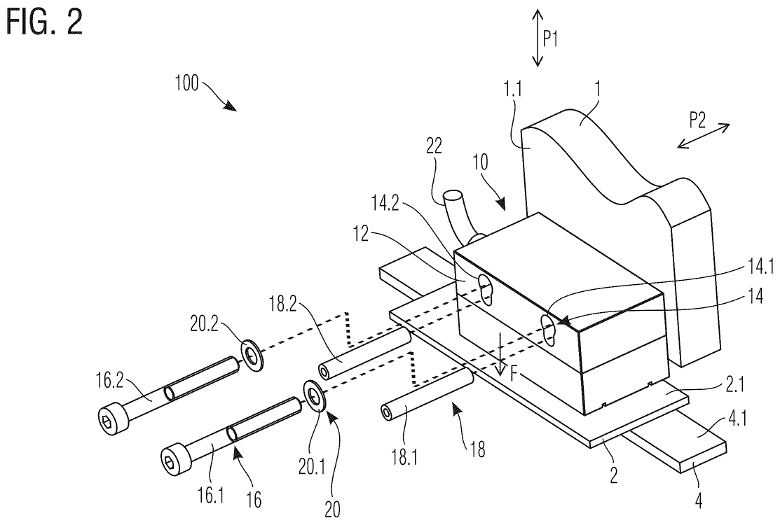

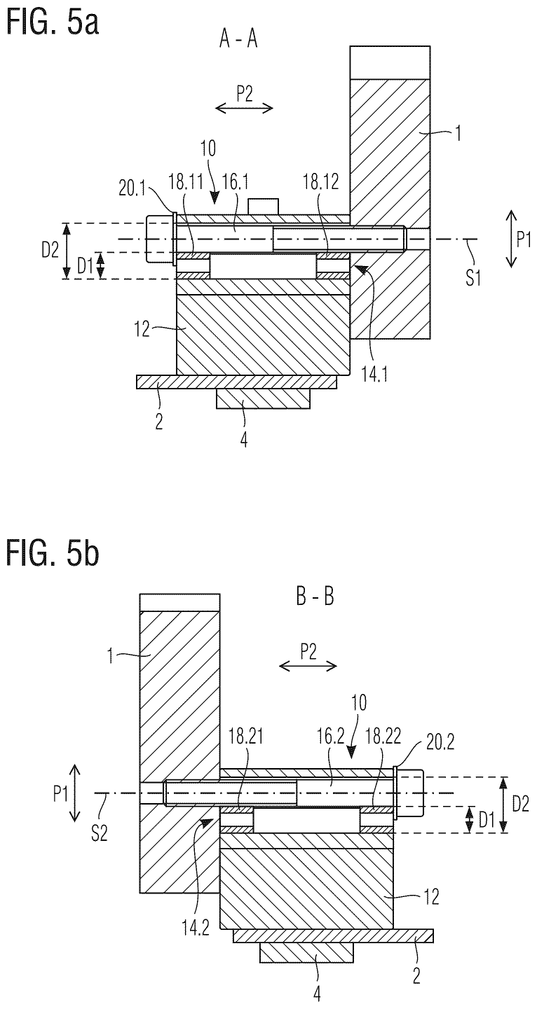

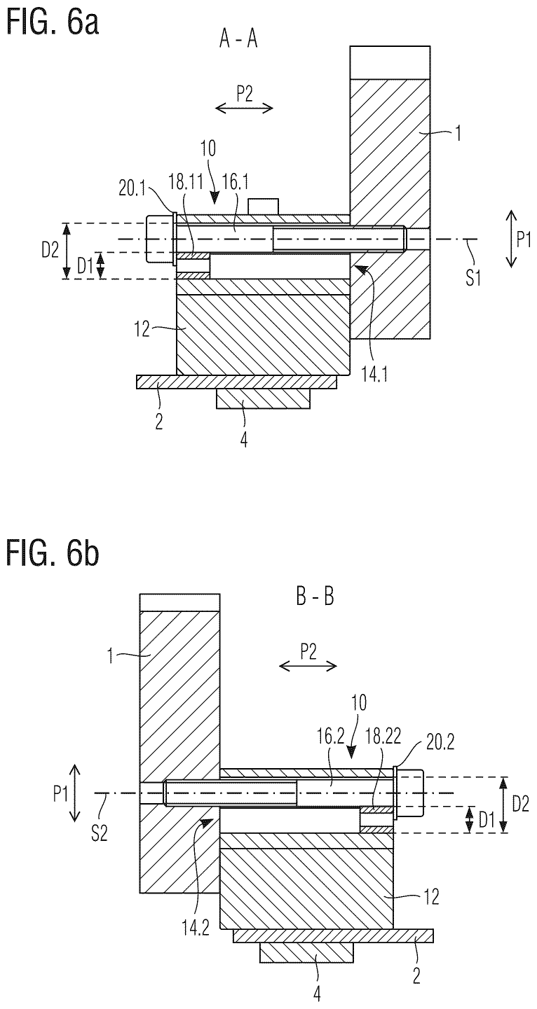

A first exemplary embodiment is explained below with reference to FIG. 1. The position-measuring device 100 according to the first exemplary embodiment is in particular a rotatory position-measuring device. A second exemplary embodiment is explained below with reference to FIGS. 2 to 4b. The position-measuring device 100 according to the second exemplary embodiment is in particular a linear position-measuring device. FIGS. 5a and 5b show an exemplary first alternative embodiment of flexible elements 18 of the position-measuring device 100 according to the second exemplary embodiment (hereinafter referred to as third exemplary embodiment). FIGS. 6a and 6b show an exemplary second alternative embodiment of the flexible elements 18 of the position-measuring device 100 according to the second exemplary embodiment (hereinafter fourth exemplary embodiment).

The position-measuring device 100 according to FIG. 1 comprises a measuring standard with a measuring graduation 4.1 and a scanning unit 10. The scanning unit 10 serves to scan the measuring graduation 4.1 of the measuring standard. A graduation carrier of the measuring standard is not shown in FIG. 1.

Furthermore, the position-measuring device 100 according to FIG. 1 comprises a reference element 2. The reference element 2 is disposed between the measuring graduation 4.1 of the measuring standard and the scanning unit 10. The reference element 2 serves as a spacer element (e.g. flexible film with a predetermined thickness). In the assembled state (i.e. in a state fastened to an object 1) of the scanning unit 10, the reference element 2 is removable from the measuring graduation 4.1 of the measuring standard and the scanning unit 10.

As shown in FIG. 1, the scanning unit 10 comprises a housing 12, a plurality of through-openings 14 (first and second through-openings 14.1, 14.2) arranged in the housing 12 and a plurality of fastening elements 16 (first and second fastening elements 16.1, 16.2). The through-openings 14 serve to fasten the scanning unit 10 to the object 1. The fastening elements 16 are configured as fastening screws or fastening bolts and extend through the through-openings 14. FIG. 1 further shows that the scanning unit 10 has several flexible elements 18 (first and second flexible elements 18.1, 18.2). The flexible elements 18 extend at least partially through the through-openings 14. The flexible elements 18 are configured to press the housing 12 of the scanning unit 10 against the reference element 2. A predetermined pressing force is shown in FIG. 1 by the arrow F.

Furthermore, FIG. 1 shows that the scanning unit 10 has several washers 20 (first and second washers 20.1, 20.2) through which the fastening elements 16 extend.

FIG. 1 shows a first direction P1 and a second direction P2. The first direction P1 is perpendicular to a surface 2.1 of the reference element 2. The second direction P2 is perpendicular to a surface 1.1 of the object 1. The predetermined pressing force F is parallel to the first direction P1. The first direction P1 and the second direction P2 are two mutually orthogonal directions.

FIG. 1 in addition shows a section 22 of a cable of the scanning unit 10.

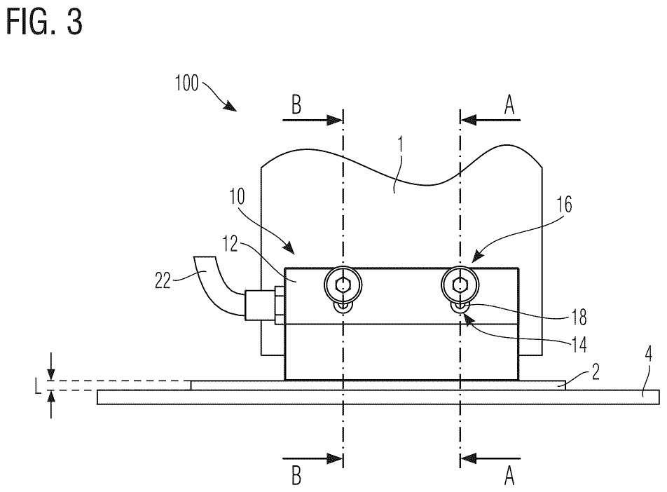

The position-measuring device according to the second exemplary embodiment differs from the position-measuring device according to the first exemplary embodiment in that the measuring standard 4 with the measuring graduation 4.1 is a scale (i.e. linear scale). The reference element 2 is disposed between the measuring standard 4 in the form of the linear scale and the scanning unit 10 (see FIG. 2). The reference element 2 in turn serves as a spacer element for setting a distance (i.e. distance L in the side view of FIG. 3) between the measuring standard 4 and the scanning unit 10. For example, the reference element 2 is a flexible film with a predetermined thickness. The predetermined thickness thereby corresponds to the distance L (see FIG. 3).

FIG. 2 on the other hand shows the predetermined pressing force F as well as the first direction P1 and the second direction P2.

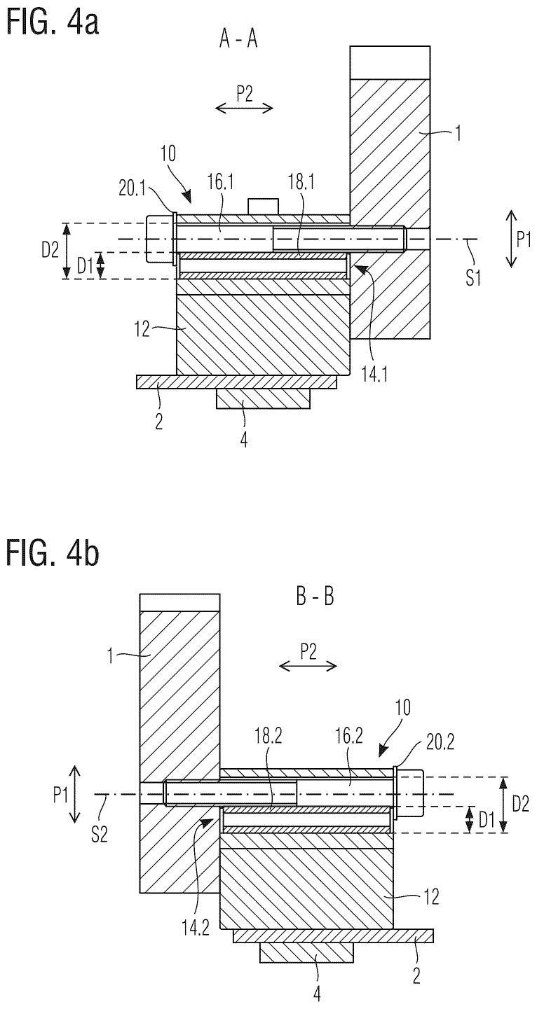

In the sectional view of FIG. 4a, the first fastening element 16.1 and the first flexible element 18.1 are shown. FIG. 4a in addition shows a longitudinal axis S1 of the first fastening element 16.1. The longitudinal axis S1 runs parallel to the second direction P2. In the sectional view of FIG. 4b, the second fastening element 16.2 and the second flexible element 18.2 are shown. FIG. 4b also shows a longitudinal axis S2 of the second fastening element 16.2. The longitudinal axis S2 runs parallel to the second direction P2.

With reference to FIG. 4a, the first flexible element 18.1 and the first fastening element 16.1 form a part of a pre-tensioning device. With reference to FIG. 4b, the second flexible element 18.2 and the second fastening element 16.2 form a further part of the pre-tensioning device. Overall, the flexible elements 18 (i.e. the first and second flexible elements 18.1, 18.2) generate the predetermined pressing force F (see FIG. 2). The pre-tensioning device thus presses the housing 12 of the scanning unit 10 against the reference element 2 in a defined manner. The predetermined pressing force F is essentially generated in the center between the sectional line A-A and the sectional line B-B (see FIGS. 2 and 3).

As can be seen in FIG. 2, the flexible elements 18 are configured to press the housing 12 of the scanning unit 10 against the reference element 2 in the first direction P1.

With reference to FIGS. 2, 4a and 4b, the flexible elements 18 extend within the through-openings 14 in the second direction P2. As can be seen in FIGS. 2, 4a and 4b, the flexible elements 18 (i.e. the first and second flexible elements 18.1, 18.2) are configured in a continuous manner in the second direction P2.

In the sectional view of FIG. 5a, the first fastening element 16.1 and partial sections 18.11, 18.12 of a first pair are shown. The partial sections 18.11, 18.12 of the first pair form the first flexible element 18.1 (here exemplary first alternative embodiment). The sectional view of FIG. 5a essentially corresponds to the sectional view of FIG. 4a.

FIG. 5b shows the second fastening element 16.2 and partial sections 18.21, 18.22 of a second pair. The partial sections 18.21, 18.22 of the second pair form the second flexible element 18.2 (here exemplary first alternative embodiment). The sectional view of FIG. 5b essentially corresponds to the sectional view of FIG. 4b.

With reference to FIGS. 5a and 5b, the flexible elements 18 thus have the first pair of partial sections 18.11, 18.12 and the second pair of partial sections 18.21, 18.22. As can be seen in FIGS. 5a and 5b, the partial sections 18.11, 18.12 of the first pair and the partial sections 18.21, 18.22 of the second pair are each arranged at two ends of the through-openings 14 opposite each other in the second direction P2. With the exemplary first alternative embodiment a particularly cost-effective and yet stable construction is achieved.

In the sectional view of FIG. 6a, the first fastening element 16.1 and a single partial section 18.11 are shown. The single partial section 18.11 forms the first flexible element 18.1 (here exemplary second alternative embodiment). The sectional view of FIG. 6a essentially corresponds to the sectional view of FIG. 4a.

In the sectional view of FIG. 6b, the second fastening element 16.2 and a single partial section 18.22 are shown. The single partial section 18.22 forms the second flexible element 18.2 (here exemplary second alternative embodiment). The sectional view of FIG. 6b essentially corresponds to the sectional view of FIG. 4b.

With reference to FIGS. 6a and 6b, the flexible elements 18 thus have the single partial section 18.11 and/or the single partial section 18.22, respectively. The single partial section 18.11 and the single partial section 18.22 are each arranged at an end of the through-openings 14 facing away from the object 1. With the exemplary second alternative embodiment a more cost-effective and yet more stable construction is achieved compared to the exemplary first alternative embodiment.

In the first and second exemplary embodiments, the flexible elements 18 are configured in a tubular manner (see FIG. 1; FIGS. 2, 4a and 4b). Furthermore, the flexible elements 18 can also have one or more tubular partial sections (see FIGS. 5a and 5b, third exemplary embodiment; FIGS. 6a and 6b, fourth exemplary embodiment). The flexible elements 18 are in particular elastically deformable elements, for example, made of silicone or rubber.

Alternatively, the flexible elements 18 may be configured differently in the through-openings 14 (e.g. continuous in the first through-opening 14.1 and interrupted in the second through-opening 14.2 and vice versa).

As can be seen in FIGS. 4a, 4b; FIGS. 5a, 5b; FIGS. 6a, 6b, the flexible elements 18 have a first extension D1 parallel to the first direction P1. Furthermore, the through-openings 14 have a second extension D2 parallel to the first direction P1. For example, the first extension D1 is smaller than half of the second extension D2.

In all exemplary embodiments, the flexible elements 18 have a first (outer) diameter (e.g. corresponding to the first extension D1). Furthermore, the fastening elements 16 have a second diameter (i.e. diameter of the shaft). For example, the first diameter is smaller than the second diameter. As can be seen in FIGS. 1 and 2, the through-openings 14 each have a shape/contour adapted to the first and second diameters.

In a further (fifth) exemplary embodiment, a single through-opening is provided instead of the plurality of through-openings 14. Furthermore, a single fastening element may be provided instead of the plurality of fastening elements 16. In addition, a single flexible element may be provided instead of the plurality of flexible elements 18.

In the fifth exemplary embodiment, the configuration/function of the various elements (i.e. single through-hole, single fastening element and single flexible element) is analogous to the first to fourth exemplary embodiments. Furthermore, in the fifth exemplary embodiment, the various elements are advantageously disposed in the center of the scanning unit 10 (i.e. at a position in the center between the sectional line A-A and the sectional line B-B according to FIG. 3). As a result, the predetermined pressing force F can in turn be generated essentially in the center of the scanning unit 10 (analogous to the first to fourth exemplary embodiments).

The invention enables a particularly high-resolution position measurement if the measuring graduation 4.1 is configured in an optically scannable manner. Alternatively, the measuring graduation 4.1 can alternatively be configured to be magnetically, inductively or capacitively scannable.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A scanning unit of a position-measuring device, the scanning unit comprising:
a housing,
one or more through-openings arranged in the housing for fastening the scanning unit to an object;
one or more fastening elements extending in each case through a respective one of the one or more through-openings; and
one or more flexible elements extending in each case at least partially through a respective one of the one or more through-openings and being configured to press the housing against a reference element.

2. The scanning unit according to claim 1, wherein a pre-tensioning device is formed by the one or more flexible elements and the one or more fastening elements.

3. The scanning unit according to claim 1, wherein the one or more flexible elements are configured to generate a predetermined pressing force by which the housing is pressed against the reference element.

4. The scanning unit according to claim 1, wherein the one or more flexible elements are configured to press the housing against the reference element in a first direction perpendicular to a surface of the reference element.

5. The scanning unit according to claim 1, wherein the one or more flexible elements extend within the one or more through-openings in a second direction perpendicular to a surface of the object, and wherein the one or more flexible elements are configured to be continuous in the second direction.

6. The scanning unit according to claim 1, wherein the one or more flexible elements each comprise a first pair of partial sections and a second pair of partial sections, wherein the partial sections of the first pair and the partial sections of the second pair are each arranged at two ends of the one or more through-openings opposite to each other in a second direction perpendicular to a surface of the object.

7. The scanning unit according to claim 1, wherein the one or more flexible elements are configured in a tubular manner.

8. The scanning unit according to claim 1, wherein the one or more flexible elements are elastically deformable elements.

9. The scanning unit according to claim 1, wherein the one or more flexible elements are made of silicone or rubber.

10. The scanning unit according to claim 1, wherein the one or more fastening elements are configured as fastening screws or fastening bolts.

11. A position-measuring device comprising a measuring standard and the scanning unit according to claim 1.

12. The position-measuring device according to claim 11, further comprising the reference element, wherein the reference element is disposed between the measuring standard and the scanning unit.

13. The position-measuring device according to claim 12, wherein the reference element is a spacer element configured to set a distance between the measuring standard and the scanning unit.

14. The position-measuring device according to claim 12, wherein the reference element is a flexible film having a predetermined thickness.

15. The position-measuring device according to claim 12, wherein the reference element is removable from the measuring standard and the scanning unit in the assembled state of the scanning unit.
